(19) United States
(12) Patent Application Publication
(10) Pub. No.: US 2026/0111489 A1
(43) Pub. Date: Apr. 23, 2026

(54) REAL-TIME DISTRIBUTED GRAPHS

(71) Applicant: NETFLIX, INC., Los Gatos, CA (US)

(72) Inventors: Vidhya ARVIND, San Ramon, CA (US); Ajit KOTI, San Jose, CA (US); Luis Antonio MEDINA, San Ramon, CA (US); Dmitriy MIKHELSON, Winnetka, IL (US); Joseph LYNCH, Gaithersburg, MD (US)

(21) Appl. No.: 19/355,776

(22) Filed: Oct. 10, 2025

Related U.S. Application Data
(60) Provisional application No. 63/708,525, filed on Oct. 17, 2024.

(51) Int. Cl. G06F 16/901

(52) U.S. Cl. CPC G06F 16/9024

(57) ABSTRACT

One embodiment sets forth a technique for storing data in a graph data structure that includes receiving a first data stream comprising a plurality of events, determining a component of the graph data structure corresponding to an event from the plurality of events, transforming the component of the graph data structure into a key-value record, publishing the key-value record into a second data stream for storage into a key-value data store, and storing the key-value record from the second data stream into the key-value data store.

### CROSS-REFERENCE TO RELATED APPLICATIONS

The present application claims the benefit of U.S. Provisional Application titled, “TECHNIQUES FOR IMPLEMENTING A REAL-TIME DISTRIBUTED GRAPH”, filed on Oct. 17, 2024, and having Ser. No. 63/708,525. The subject matter of this related application is hereby incorporated herein by reference.

### BACKGROUND

### Field of the Various Embodiments

Embodiments of the present disclosure relate generally to computer science and computer networks, and more specifically, to techniques for implementing a real-time distributed graph.

### Description of the Related Art

Many organizations rely heavily on data to support a wide range of operations, analyses, and decision-making processes. Data enables organizations to gain valuable insights, improve workflows, and achieve strategic objectives. In some scenarios, a graph data structure is desirable to model relationships between entities and to provide such relationships as inputs or data points for various purposes. In general, a graph data structure includes nodes that are connected to one another via edges. A graph can be useful to solve problems or discover information about entities that are interconnected. For example, people in a social network can be modeled using a graph due to the relationships among the people. As another example, graphs can be useful for fraud detection purposes. In this scenario, a user account can be linked to one or more IP addresses, device identifiers, or payment methods. The various properties of the user account can be modeled using a graph, and systems can search or traverse the graph to discover relationships between the user account and other entities for fraud detection purposes.

In some organizations, the size of datasets can be extremely large, which makes efficiently storing data in a graph and then efficiently querying the graph to understand the relationships between entities impractical. For example, an organization with internet-scale data that potentially involves millions or billions of nodes can cause several drawbacks to emerge. One drawback of conventional approaches for organizing data in a graph includes the memory overhead associated with such approaches for storing the graph. Typical approaches to implementing a graph involve heavy usage of pointers, which result in significant memory management overhead. Another drawback involves traversal of the graph. For example, in implementations that involve significant pointer usage, traversing the graph to determine the relationships between entities is computationally expensive and results in substantial memory overhead. Traversing a large graph can involve multi-hop traversals, which can be slow and expensive in graph data structures that house a large amount of data, such as in larger graphs that house internet-scale data.

As the foregoing illustrates, what is needed in the art are more effective techniques for implementing graphs in environments where internet scale data is being stored in the graph.

### SUMMARY

One embodiment sets forth a computer-implemented method that includes receiving a first data stream comprising a plurality of events, determining a component of a graph data structure corresponding to an event from the plurality of events, transforming the component of the graph data structure into a key-value record, publishing the key-value record into a second data stream for storage into a key-value data store, and storing the key-value record from the second data stream into the key-value data store.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to the prior art is that the disclosed techniques provide a mechanism to utilize a graph data structure with internet-scale data. The process of storing data into the graph is separated into an initial node and edge creation stage. Subsequently, the nodes and edges are stored in a key-value store where nodes are stored together with other nodes of the same node type. Similarly, edges are stored together with other edges of the same edge type. In this manner, memory and network overhead associated with traversing graphs across multiple storage partitions is reduced. Additionally, the disclosed techniques also provide an application programming interface (API) that allows for efficient graph traversal. Reducing the memory and network overhead associated with graph implementation enables efficient storage of data extracted from real-time event streams in a graph. Moreover, the data model utilized by the disclosed techniques facilitates efficient graph traversal, particularly when storing a large number of nodes and edges commonly encountered with internet-scale data.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of the various embodiments.

FIG. 2 is a more detailed illustration of how a graph data structure is stored using the network infrastructure of FIG. 1, according to various embodiments.

FIG. 3 illustrates how the graph traversal API associated with the distributed graph application can facilitate querying of a graph data structure stored in graph storage, according to various embodiments.

FIG. 4 sets forth a flow diagram of method steps for storing data from an input data stream into a graph data structure in graph storage, according to various embodiments.

FIG. 5 sets forth a flow diagram of method steps for traversing a graph data structure stored in graph storage, according to various embodiments.

FIG. 6 is a more detailed illustration of the server device of FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

As described herein, graph data structures are utilized for various purposes. For example, a graph data structure can be used to model relationships between entities and to provide such relationships as inputs or data points for various purposes. A graph can be useful to solve problems or discover information about entities that are interconnected. For example, graphs can be useful for fraud detection purposes. In this scenario, a user account can be linked to one or more IP addresses, device identifiers, or payment methods. The various properties of the user account can be modeled using a graph, and systems can search or traverse the graph to discover relationships between the user account and other entities for fraud detection purposes.

In some organizations, the size of datasets can be extremely large, which makes efficiently storing data in a graph and then efficiently querying the graph to understand the relationships between entities impractical. One drawback of conventional approaches for organizing data in a graph includes the memory overhead associated with such approaches for storing the graph. Typical approaches to implementing a graph involve heavy usage of pointers, which result in significant memory management overhead. Another drawback involves traversal of the graph. For example, in implementations that involve significant pointer usage, traversing the graph to determine the relationships between entities is computationally expensive and results in substantial memory overhead. Traversing a large graph can involve multi-hop traversals, which can be slow and expensive in graph data structures that house a large amount of data, such as in larger graphs that house internet-scale data.

To address the foregoing drawbacks, techniques for efficient storage and traversal of a graph data structure designed to store and query internet-scale data are disclosed. A graph data structure is separated into a pipelined structure, thereby enabling the storage of the components as key-value tables within various key-value namespaces. The process of storing data into the graph can occur in real-time. A data stream that includes a plurality of events is received, and nodes and edges are either extracted or identified based on the data present in such data stream. The nodes and edges undergo transformation into key-value records. Such records are serialized and stored into respective key-value tables that are generated for each type of node or edge in the graph.

One technical advantage of the disclosed techniques relative to the prior art is that the disclosed techniques provide a mechanism to utilize a graph data structure with internet-scale data. The process of storing data into the graph is separated into an initial node and edge creation stage. Subsequently, the nodes and edges are stored in a key-value store where nodes are stored together with other nodes of the same node type.

Similarly, edges are stored together with other edges of the same edge type. In this manner, memory and network overhead associated with traversing graphs across multiple storage partitions is reduced. Additionally, the disclosed techniques also provide an application programming interface (API) that allows for efficient graph traversal. Reducing the memory and network overhead associated with graph implementation enables efficient storage of data extracted from real-time event streams in a graph. Moreover, the data model utilized by the disclosed techniques facilitates efficient graph traversal, particularly when storing a large number of nodes and edges commonly encountered with internet-scale data.

These technical advantages represent one or more technological improvements over prior art approaches.

### System Overview

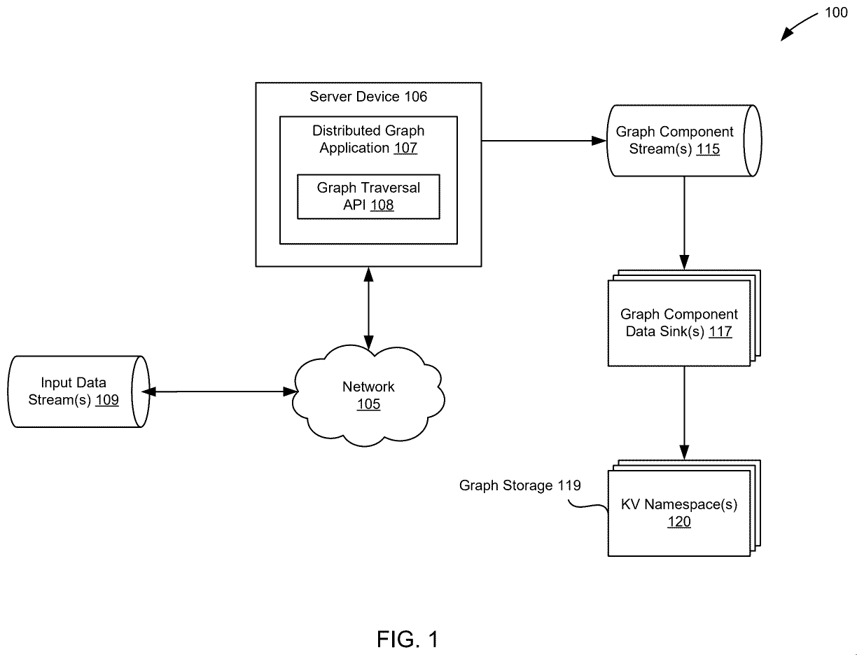

FIG. 1 illustrates a network infrastructure 100 configured to implement one or more aspects of various embodiments. As shown, the network infrastructure 100 includes a server device 106, an input data stream 109, a graph component stream 115, a graph data sink 117, and graph storage 119, each of which are connected via a communications network 105. The communications network 105 can represent, for example, any technically feasible network or number of networks, including a wide area network (WAN) such as the Internet, a local area network (LAN), a Wi-Fi network, a cellular network, or a combination thereof.

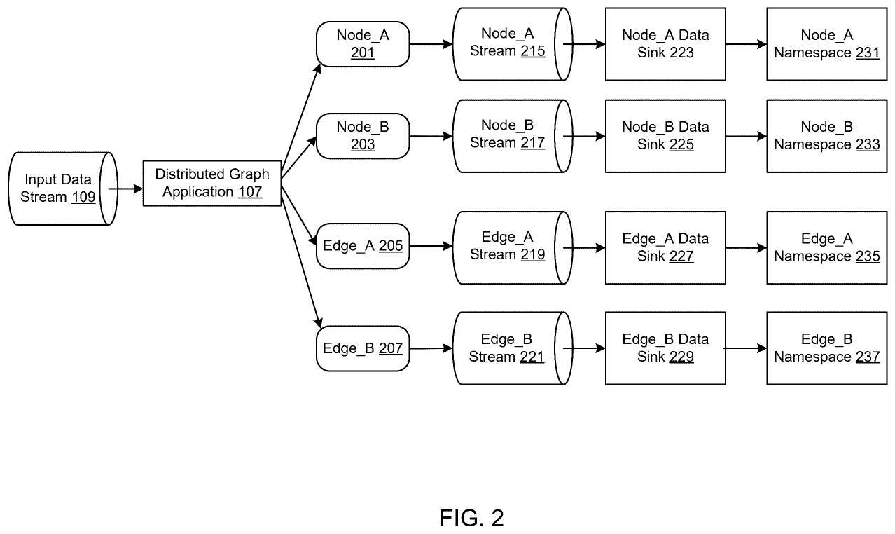

The server device 106 can represent one or more computing devices, such as rack servers, blade servers, tower servers, microservers, hyper-converged infrastructure servers, mainframe servers, and others, that are implemented by and accessible to an organization. The server device 106 executes, without limitations, a distributed graph application 107 that ingests data from input data stream 109 and stores one or more portions of the data in a graph data structure that is stored across various key-value namespaces, or KV namespace 120, in graph storage 119. The various components of the graph data structure, such as the nodes and edges that connect the nodes to one another, are distributed across various namespaces in a key-value data store. The distributed graph application 107 also includes a graph traversal API 108 that can be accessed by users or other services to query or traverse a graph data structure that is stored within graph storage 119 by distributed graph application 107. A more detailed explanation of the architecture of the distributed graph application 107, as well as the functionalities implemented by the distributed graph application 107, is provided below in conjunction with FIGS. 2-4.

The input data stream 109 represents one or more incoming data streams in which the distributed graph application 107 stores information in a graph data structure. For example, an incoming data stream can represent login events for one or more user logins to a network-accessible service. The login event can include information such as a network address of the device from which the login event originates, a device type associated with the device, a username or other user identifier, geographic information associated with a location of the device, an application type or version through which the user is logging into the service, a session identifier, a timestamp, and other information associated with the login event. In one example, a graph can be constructed that stores various information about the login event into nodes and edges that connect the nodes to one another. For example, the information stored in the graph data structure can include a user identity, a device identifier, a network address, a session identifier, and a timestamp. Another example of an input data stream 109 is a stream of playback events that correspond to when a user initiates or completes playback of a title in a streaming video service. In this example, the playback event can specify an account identifier, a user agent or device, a network address, a location from which the title is played back, and other information about the playback of a title. Edges can connect the nodes to one another to define relationships between the nodes that are associated with the respective events. Input data stream 109 can be implemented as an event streaming platform that includes one or more real-time data pipelines. An example of such a platform includes Apache Kafka.

Distributed graph application 107 stores the graph data structure as multiple key-value tables in graph storage 119. Accordingly, graph storage 119 represents a service or abstraction layer through which data can be stored in one or more key-value stores, which are represented by KV namespace 120. Logically, graph storage 119 is accessible to distributed graph application 107 as a key-value store in which multiple namespaces can be created and managed by graph storage 119. In examples of the disclosure, a particular node type is stored in its own KV namespace 120. For example, nodes associated with a login event that represent a user identifier linked to the login event can be stored in their own KV namespace 120 within graph storage 119.

Similarly, edges connecting these nodes to other nodes can be stored in a different KV namespace 120 within graph storage 119 as well.

A node of the graph is stored in a KV namespace 120 as a record with a record identifier. The record identifier can be used to query the KV namespace 120 for specific records, which is used when performing a graph traversal, for example. The record identifier can be unique with respect to other records within the same KV namespace 120. The record can include one or more key-value entries that include one or more properties of the node and respective values for the properties. Each different type of node can have different properties or quantities of properties. An edge is also stored in a KV namespace 120 as a record. In the case of an edge, the record identifier is the record identifier of a node from which the edge begins. The record then stores one or more other record identifiers corresponding to nodes to which the edge is connected. To represent a bidirectional edge, a separate record in a separate KV namespace 120 is utilized. In other words, a different edge type in a different KV namespace 120 is used to model the other direction of the edge.

The underlying datastore utilized for graph storage 119 can represent any computer, service, entity, etc., that allows KV namespaces 120 to be created, managed, and accessed. For example, the datastore can represent a distributed database that is optimized for high availability and scalability, a relational database system that is designed for structured data, a spreadsheet service, a word processing service, a presentation service, etc., that is accessible through a web-based interface, or a search platform capable of indexing and retrieving volumes of data. The datastore can also represent a stream processing system configured to manage real-time data flows, an object storage service configured to implement scalable data storage and retrieval, or a platform that maintains immutable datasets for consistent access across distributed systems. It is noted that the foregoing examples are not meant to be limiting, and that the datastore can manage any number, type, form, etc., of KV namespaces 120, at any level of granularity, consistent with the scope of this disclosure.

Graph component streams 115 represent one or more stream processing systems configured to manage real-time data flows from distributed graph application 107. In some embodiments, distributed graph application 107 receives an input data stream 109 and outputs various graph components, such as nodes and edges, for storage in graph storage 119. Because of the real-time nature of the incoming data from input data stream 109, the information about the edges and nodes is output to respective graph component streams 115. In one implementation, each type of graph component, such as a particular node type or a particular edge type, is output into a different graph component stream 115 that is executed to receive only graph components of a particular type. A respective graph component stream 115 outputs the data to a graph component data sink 117, which stores the data characterizing the graph component as a record in a KV namespace 120 within graph storage 119. An example of a respective graph component stream 115 can be implemented as an event streaming platform that includes one or more real-time data pipelines, such as an Apache Kafka data pipeline.

Graph component data sink 117 represents one or more systems that operate as a storage layer for storage of data about the graph data structure into one or more KV namespaces 120 in graph storage 119. In some embodiments, each node type or edge type is associated with a graph component data sink 117 that is configured to store only graph components of a particular type into graph storage 119. A graph component data sink 117 stores the data characterizing the graph component as a record in a specified KV namespace 120 within graph storage 119.

### Real-Time Distributed Graph Architecture

FIG. 2 is a more detailed illustration of the distributed graph application 107 of FIG. 1, according to various embodiments. As shown, the distributed graph application 107 can receive an input data stream 109 that includes data for storage into a graph data structure. In some embodiments, the distributed graph application 107 can receive multiple input data streams 109 that include data for storage into the same graph data structure or into different graph data structures. In operation, the distributed graph application 107 reads the data from the input data stream 109 and extracts the data from the input data stream 109 that is to be stored into the graph data structure. In one example, the distributed graph application 107 identifies the data for storage into nodes or edges of the graph from the input data stream 109. For example, returning to the example of a login event, the distributed graph application 107 identifies the data to be mapped onto nodes and edges in the graph data structure defined by a user or administrator of the graph. In some examples, the distributed graph application 107 identifies or generates one or more enrichments to the nodes and edges. Enrichments to a graph data structure can include augmenting the data extracted from the input data stream 109 with additional data, context, or structure to improve the usefulness of the information stored in the graph. In one embodiment, the distributed graph application 107 can add metadata or properties to nodes or edges. In another example, the distributed graph application 107 can generate additional nodes or edges of the graph based on information from the input data stream 109. In some cases, the distributed graph application 107 retrieves data external to the input data stream 109 to add to or supplement nodes or edges that are identified based on information in the input data stream 109.

The distributed graph application 107 generates nodes and/or edges in real time based on the data extracted from the input data stream 109. In one example, the nodes and/or edges are generated by the distributed graph application 107 using a dataflow pipeline that ingests data from the input data stream 109, transforms the data into nodes and/or edges through stateless or stateful data transformation, and generates records corresponding to the nodes or edges for storage into graph storage 119. In some examples, the distributed graph application 107 performs data deduplication based on the input data stream 109 to prevent unnecessary storage of duplicate data into the graph, which minimizes data redundancy and improves the efficiency of the storage process.

In the example scenario shown in FIG. 2, the distributed graph application 107 has identified node_a 201, node_b 203, edge_a 205, and edge_b 207 as components of the graph that should be added to the graph. Accordingly, the distributed graph application 107 generates data records corresponding to each of node_a 201, node_b 203, edge_a 205, and edge_b 207. The data records can be formatted into a binary serialization format, such as a JSON or Avro record. The data records corresponding to node_a 201, node_b 203, edge_a 205, and edge_b 207 are then published into respective graph component streams 115: node_a stream 215, node_b stream 217, edge_a stream 219, and edge_b stream 221. As noted above, the respective graph component streams 115 correspond to each type of component associated with the graph data structure. The respective graph component streams 115 then provide the data records corresponding to node_a 201, node_b 203, edge_a 205, and edge_b 207 to respective graph component data sinks 117. The respective graph component data sinks 117 are node_a data sink 223, node_b data sink 225, edge_a data sink 227, and edge_b data sink 229. The respective graph component data sinks 117 then store the data records corresponding to node_a 201, node_b 203, edge_a 205, and edge_b 207 into KV namespace 120 corresponding to the respective graph components. As shown in the example of FIG. 2, node_a data sink 223 stores node_a 201 into node_a namespace 231, node_b data sink 225 stores node_b 203 into node_b namespace 233, edge_a data sink 227 stores edge_a 205 into edge_a namespace 235, and edge_b data sink 229 stores edge_b 207 into edge_b namespace 237.

The distributed graph application 107 can also include an enrichments service or API that continually updates or enriches the graph with data or properties from input data stream 109 or external data sources. An enrichments API can also permit a user or another application or service to generate and add enrichments to the graph data structure stored in graph storage 119. Additionally, the distributed graph application 107 can store snapshots of the graph represented in the graph storage 119 in a data lake or data store separate from graph storage 119. The distributed graph application 107 or other systems can perform analytics or deep traversals of the graph data structure based on the snapshots rather than affecting the real-time performance of the graph data structure by accessing the graph through the distributed graph application 107.

By structuring the processing and storage of the graph data structure into a data pipeline that includes one or more input data streams 109 with event data that is streamed in real time to the distributed graph application 107, which creates nodes and edges or graph components into serialized data records that are again streamed into graph storage 119, the distributed graph application 107 facilitates real-time storage of a graph data structure when the input data stream 109 provides internet-scale data streams.

### Graph Traversal API

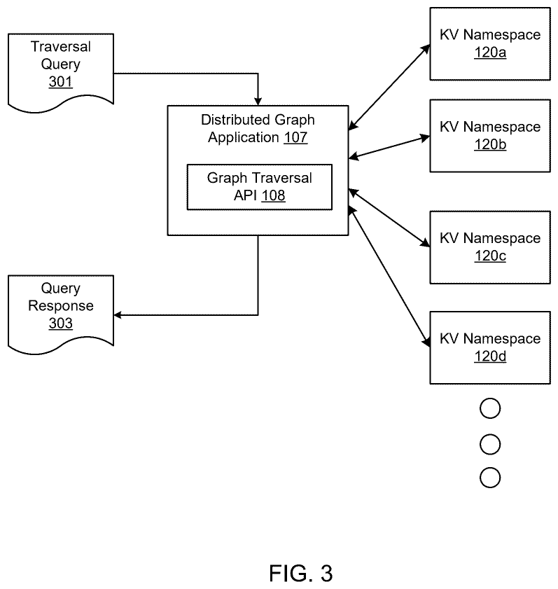

FIG. 3 illustrates how the graph traversal API 108 associated with the distributed graph application 107 can facilitate querying of a graph data structure stored in graph storage 119 according to various embodiments. Traversal query 301 represents a request to query or traverse the graph. For example, a user submits a traversal query 301 through a user interface or a query engine that allows the user to interact with or access the data in the graph data structure. In this scenario, the graph traversal API 108 returns query results to the user. As another example, another application or system queries the graph data structure using graph traversal API 108 to query information or data stored in the graph based on an input query. In this scenario, the graph traversal API 108 returns query results to the requesting application or system.

In one embodiment, in response to receiving a traversal query 301, graph traversal API 108 performs a breadth-first search traversal of the graph stored in graph storage 119 based upon the query. For example, graph traversal API 108 selects one or more starting nodes based on the traversal query 301 and then specifies the depth or hops that the search should use to traverse the graph data structure. Traversals are performed by graph traversal API 108 as a parallelized set of requests to the underlying graph storage 119, or respective KV namespaces 120 corresponding to the various nodes and edges of the graph.

Based on the complexity of the traversal query 301, a query can span across several KV namespaces 120 stored in graph storage 119 or another underlying database or data store in which the KV namespaces 120 are stored. As one of the parallelized requests completes, graph traversal API 108 determines whether additional nodes exist from the outgoing edges of a resulting node and continues traversal of the graph. Once all results have been read, graph traversal API 108 performs deserialization of the results of traversal query 301 in order to transform the data for output. For example, graph traversal API 108 can support one or more schemas that specify how the data should be output from the graph data structure. The schema can specify node and edge types supported by the graph along with respective sets of properties. Accordingly, once graph traversal based on traversal query 301 has been completed by graph traversal API 108, query result 303 is returned to the requesting user, application, or system.

### Storing Data in Graph Data Structure

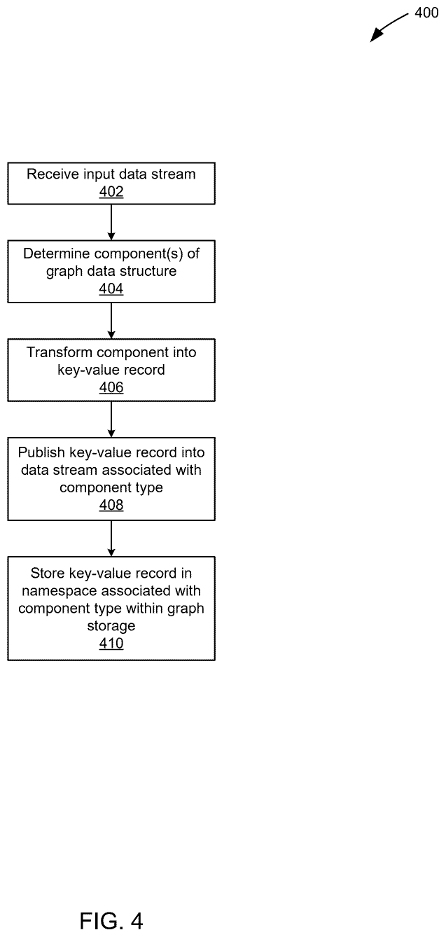

FIG. 4 sets forth a flow diagram of method steps for storing data from an input data stream 109 into a graph data structure in graph storage 119, according to various embodiments. As shown in FIG. 4, a method 400 begins at step 402, where the distributed graph application 107 receives input data stream 109. The input data stream 109 can include one or more events that include data for storage in a graph data structure. In some cases, more than one input data stream 109 can be received by distributed graph application 107, and distributed graph application 107 can process data on the input data stream 109 to extract data for storage into or enrichment of the graph data structure. Accordingly, distributed graph application 107 extracts data from the input data stream 109 to generate nodes or edges for insertion into a graph data structure represented in KV namespaces 120 in graph storage 119.

At step 404, distributed graph application 107 determines one or more components of a graph data structure based on the data in the input data stream 109. For example, distributed graph application 107 identifies nodes or edges to generate and store in the graph data structure based on the data extracted from the input data stream 109. The components of the graph data structure represent the data stored in the graph and the relationships between the data in the graph.

At step 406, the distributed graph application 107 transforms the identified components of the graph data structure into key-value records that can be stored in one or more KV namespaces 120 in graph storage 119. As noted above, each of the different types of nodes or edges in the graph are associated with their own respective KV namespace 120 in graph storage 119 because the graph is represented in graph storage 119 as a series of key-value tables that store a plurality of key-value records corresponding to respective graph nodes and edges.

At step 408, distributed graph application 107 publishes the key-value records into respective graph component streams 115. As noted above, respective graph component streams 115 represent one or more stream processing systems configured to manage real-time data flows from distributed graph application 107. Each type of graph component, such as a particular node type or a particular edge type, is output into a different graph component stream 115 that is executed to receive only graph components of a particular type. The respective graph component streams 115 output the data to a graph component data sink 117, which stores the data characterizing the graph component as a record in a KV namespace 120 within graph storage 119.

At step 410, the key-value records published into graph component data sink 117 are stored in graph storage 119. The key-value records are stored in respective KV namespaces 120 by a respective graph component data sink 117. Graph component data sinks 117 are one or more systems that operate as a storage layer for storage of data about the graph data structure in one or more KV namespaces 120 in graph storage 119. The graph component data sink 117 stores the key-value records in the KV namespaces 120 corresponding to each of the graph component types.

### Traversing Graph Data Structure

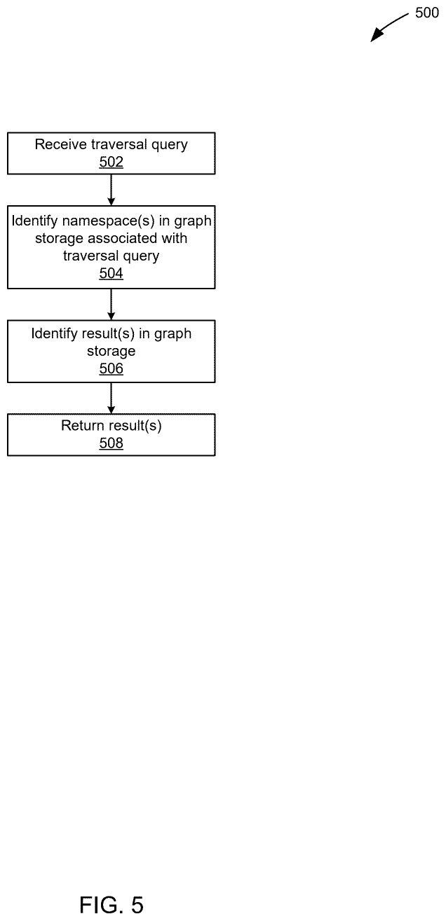

FIG. 5 sets forth a flow diagram of method steps for traversing a graph data structure stored in graph storage 119, according to various embodiments. As shown in FIG. 5, a method 500 begins at step 502, where the distributed graph application 107 or graph traversal API 108 receives a traversal query 301. Traversal query 301 represents a request to query or traverse the graph. In one embodiment, in response to receiving a traversal query 301, graph traversal API 108 performs a breadth-first search traversal of the graph stored in graph storage 119 based upon the query. For example, graph traversal API 108 selects one or more starting nodes based on the traversal query 301 and then specifies the depth or hops that the search should use to traverse the graph data structure. Traversals performed by graph traversal API 108 occur as a parallelized set of requests to the underlying graph storage 119 or respective KV namespaces 120 corresponding to the various nodes and edges of the graph.

At step 504, graph traversal API 108 identifies one or more KV namespaces 120 in the graph that are associated with the traversal query 301. For example, graph traversal API 108 selects one or more starting nodes based on the traversal query 301 and then specifies the depth or hops that the search should use to traverse the graph data structure. Traversals performed by graph traversal API 108 occur as a parallelized set of requests to the underlying graph storage 119 or respective KV namespaces 120 corresponding to the various nodes and edges of the graph.

At step 506, graph traversal API 108 identifies one or more results in the graph data structure based on traversal query 301. In some embodiments, once the results have been identified, graph traversal API 108 performs deserialization of the results of a traversal query 301 in order to transform the data for output. For example, graph traversal API 108 can support one or more schemas that specify how the data should be output from the graph data structure. The schema can specify node and edge types supported by the graph along with their respective set of properties. At step 508, graph traversal API 108 returns query results 303 to a requesting user, application, or system.

### Server Device Overview

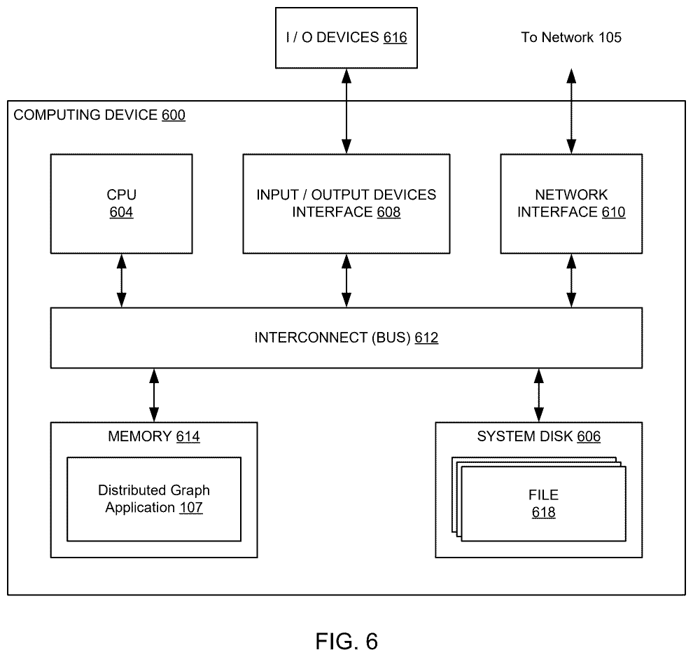

FIG. 6 is a more detailed illustration of a server device 106 of FIG. 1, according to various embodiments. As shown, the server device 106 includes, without limitation, a central processing unit (CPU) 604, a system disk 606, an input/output (I/O) devices interface 608, a network interface 610, an interconnect 612, and a system memory 614.

The CPU 604 is configured to retrieve and execute programming instructions, such as distributed graph application 107, stored in the system memory 614. Similarly, the CPU 604 is configured to store application data (e.g., software libraries) and retrieve application data from the system memory 614. The interconnect 612 is configured to facilitate transmission of data, such as programming instructions and application data, between the CPU 604, the system disk 606, I/O devices interface 608, the network interface 610, and the system memory 614. The I/O devices interface 608 is configured to receive input data from I/O devices 616 and transmit the input data to the CPU 604 via the interconnect 612. For example, I/O devices 616 can include one or more buttons, a keyboard, a mouse, and/or other input devices. The I/O devices interface 608 is further configured to receive output data from the CPU 604 via the interconnect 612 and transmit the output data to the I/O devices 616.

The system disk 606 can include one or more hard disk drives, solid state storage devices, or similar storage devices. The system disk 606 is configured to store non-volatile data such as files 618 (e.g., audio files, video files, subtitles, application files, software libraries, etc.). In some embodiments, the network interface 610 is configured to operate in compliance with the Ethernet standard.

The system memory 614 includes the distributed graph application 107. In a clustered environment, distributed graph application 107 on each server device 106 can be responsible for executing various operations to ensure the server device 106 effectively participates with other server devices 106 in the cluster. In this regard, the distributed graph application 107 can be configured to service and/or respond to requests, commands, etc., received from other instances of distributed graph application 107. For example, the server manager 617 can perform tasks such as synchronizing data with other servers 110, balancing workloads (e.g., internally, with other servers 110, etc.), and managing resource allocation. The distributed graph application 107 can also implement operations that ensure the server device 106 is aware of its role within the cluster, maintain communication with other control servers 160, and contribute to collective tasks such as handling failovers, scaling resources, and the like. The distributed graph application 107 can also monitor the health of the server device 106, apply configuration updates, and coordinate state transitions to ensure that the server device 106 aligns with the overall performance, availability, and redundancy objectives of the cluster. It is noted that the foregoing examples are not meant to be limiting, and that the distributed graph application 107 can be configured to implement any number, type, form, etc., of operation(s), at any level of granularity, to effectively manage the functionality of the server device 106 both individually and collectively within the associated cluster, consistent with the scope of this disclosure.

It will be appreciated that the server device 106, distributed graph application 107, and other components described above in conjunction with FIGS. 1-5 are illustrative, and that variations and modifications are possible. The connection topologies, including the number of CPUs and memories, may be modified as desired, and in certain embodiments, one or more components shown in FIGS. 1-5 may not be present. Further, in certain embodiments, one or more components shown in FIGS. 1-5 may be implemented as virtualized resources in a virtual computing environment and/or a cloud computing environment.

In sum, the embodiments set forth techniques for efficient storage and traversal of a graph data structure designed to store and query internet-scale data. The graph data structure is separated into a pipelined structure, thereby enabling the storage of the components as key-value tables within various key-value namespaces. The process of storing data into the graph can occur in real-time. A data stream that includes a plurality of events is received, and nodes and edges are either extracted or identified based on the data present in such data stream. The nodes and edges undergo transformation into key-value records. Such records are serialized and stored into respective key-value tables that are generated for each type of node or edge in the graph.

One technical advantage of the disclosed techniques relative to the prior art is that the disclosed techniques provide a mechanism to utilize a graph data structure with internet-scale data. The process of storing data into the graph is separated into an initial node and edge creation stage. Subsequently, the nodes and edges are stored in a key-value store where nodes are stored together with other nodes of the same node type. Similarly, edges are stored together with other edges of the same edge type. In this manner, memory and network overhead associated with traversing graphs across multiple storage partitions is reduced. Additionally, the disclosed techniques also provide an application programming interface (API) that allows for efficient graph traversal. Reducing the memory and network overhead associated with graph implementation enables efficient storage of data extracted from real-time event streams in a graph. Moreover, the data model utilized by the disclosed techniques facilitates efficient graph traversal, particularly when storing a large number of nodes and edges commonly encountered with internet-scale data.

Aspects of the subject matter described herein are set out in the following numbered clauses.
1. In some embodiments, a computer-implemented method for storing data in a graph data structure comprises receiving a first data stream comprising a plurality of events, determining a component of the graph data structure corresponding to an event from the plurality of events, transforming the component of the graph data structure into a key-value record, publishing the key-value record into a second data stream for storage into a key-value data store, and storing the key-value record from the second data stream into the key-value data store.
2. The computer-implemented method of clause 1, wherein the component of the graph data structure comprises a component type, the component type specifying a node type or an edge type.
3. The computer-implemented method of clauses 1 or 2, further comprising collapsing duplicate events from the plurality of events into the key-value record.
4. The computer-implemented method of any of clauses 1-3, wherein transforming the component of the graph data structure into the key-value record comprises generating an identifier for the component of the graph data structure, storing the identifier for the component as a key for the key-value record, and storing one or more component properties as a value of the key-value record.
5. The computer-implemented method of any of clauses 1-4, wherein the component comprises an edge in the graph data structure, and the one or more component properties comprise one or more identifiers specifying one or more nodes to which the edge is linked.
6. The computer-implemented method of any of clauses 1-5, wherein the one or more identifiers are stored in the key-value record as an adjacency list.
7. The computer-implemented method of any of clauses 1-6, wherein storing the key-value record from the second data stream into the key-value data store comprises identifying a namespace within the key-value data store corresponding to a component type of the component or a property within the component.
8. The computer-implemented method of any of clauses 1-7, wherein the namespace within the key-value data store is uniquely associated with the component type of the component or the property within the component.
9. The computer-implemented method of any of clauses 1-8, wherein the second data stream is uniquely associated with the component type of the component or the property within the component.
10. The computer-implemented method of any of clauses 1-9, further comprising determining a second component of the graph data structure corresponding to a second event from the plurality of events, transforming the second component of the graph data structure into a second key-value record, publishing the second key-value record into a third data stream for storage into the key-value data store, and storing the second key-value record from the third data stream into the key-value data store.
11. The computer-implemented method of any of clauses 1-10, wherein the key-value record is stored in a first namespace within the key-value data store and the second key-value record is stored in a second namespace within the key-value data store that is different from the first namespace.
12. In some embodiments, one or more non-transitory computer readable media store instructions that, when executed by one or more processors, cause the one or more processors to store data in a graph data structure, by performing the steps of receiving a first data stream comprising a plurality of events, determining a component of the graph data structure corresponding to an event from the plurality of events, transforming the component of the graph data structure into a key-value record, publishing the key-value record into a second data stream for storage into a key-value data store, and storing the key-value record from the second data stream into the key-value data store.
13. The one or more non-transitory computer readable media of clause 12, wherein the steps further comprise receiving a request to traverse the graph data structure based upon a query via an application programming interface (API), performing a breadth-first search traversal of the graph data structure based upon the query, and returning one or more results based upon the query via the API.
14. The one or more non-transitory computer readable media of clauses 12 or 13, wherein the key-value data store comprises a plurality of namespaces, wherein each namespace of the plurality of namespaces corresponds to at least one of a node type or an edge type of the key-value data store.
15. The one or more non-transitory computer readable media of any of clauses 12-14, wherein the steps further comprise receiving a request to traverse the graph data structure based upon a query via an application programming interface (API), performing a breadth-first search traversal of the graph data structure based upon the query based on a set of parallelized queries across the plurality of namespaces, and returning one or more results based upon the query via the API.
16. The one or more non-transitory computer readable media of any of clauses 12-15, wherein the component of the graph data structure comprises a component type, the component type specifying a node type or an edge type.
17. The one or more non-transitory computer readable media of any of clauses 12-16, wherein the steps further comprise collapsing duplicate events from the plurality of events into the key-value record.
18. The one or more non-transitory computer readable media of any of clauses 12-17, storing the identifier for the component as a key for the key-value record, and storing one or more component properties as a value of the key-value record.
19. The one or more non-transitory computer readable media of any of clauses 12-18, wherein the component comprises an edge in the graph data structure, and the one or more component properties comprise one or more identifiers specifying one or more nodes to which the edge is linked.
20. In some embodiments, a computer system comprises one or more memories that include instructions, and one or more processors that are coupled to the one or more memories and, when executing the instructions, are configured to store data in a graph data structure, by performing the operations of receiving a first data stream comprising a plurality of events, determining a component of the graph data structure corresponding to an event from the plurality of events, transforming the component of the graph data structure into a key-value record, publishing the key-value record into a second data stream for storage into a key-value data store, and storing the key-value record from the second data stream into the key-value data store.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system. ” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for storing data in a graph data structure, the method comprising:
receiving a first data stream comprising a plurality of events;
determining a component of the graph data structure corresponding to an event from the plurality of events;
transforming the component of the graph data structure into a key-value record;
publishing the key-value record into a second data stream for storage into a key-value data store; and
storing the key-value record from the second data stream into the key-value data store.

2. The computer-implemented method of claim 1, wherein the component of the graph data structure comprises a component type, the component type specifying a node type or an edge type.

3. The computer-implemented method of claim 1, further comprising collapsing duplicate events from the plurality of events into the key-value record.

4. The computer-implemented method of claim 1, wherein transforming the component of the graph data structure into the key-value record comprises:
generating an identifier for the component of the graph data structure;
storing the identifier for the component as a key for the key-value record; and
storing one or more component properties as a value of the key-value record.

5. The computer-implemented method of claim 4, wherein the component comprises an edge in the graph data structure, and the one or more component properties comprise one or more identifiers specifying one or more nodes to which the edge is linked.

6. The computer-implemented method of claim 5, wherein the one or more identifiers are stored in the key-value record as an adjacency list.

7. The computer-implemented method of claim 1, wherein storing the key-value record from the second data stream into the key-value data store comprises identifying a namespace within the key-value data store corresponding to a component type of the component or a property within the component.

8. The computer-implemented method of claim 7, wherein the namespace within the key-value data store is uniquely associated with the component type of the component or the property within the component.

9. The computer-implemented method of claim 7, wherein the second data stream is uniquely associated with the component type of the component or the property within the component.

10. The computer-implemented method of claim 1, further comprising:
determining a second component of the graph data structure corresponding to a second event from the plurality of events;
transforming the second component of the graph data structure into a second key-value record;
publishing the second key-value record into a third data stream for storage into the key-value data store; and
storing the second key-value record from the third data stream into the key-value data store.

11. The computer-implemented method of claim 10, wherein the key-value record is stored in a first namespace within the key-value data store and the second key-value record is stored in a second namespace within the key-value data store that is different from the first namespace.

12. One or more non-transitory computer readable media storing instructions that, when executed by one or more processors, cause the one or more processors to store data in a graph data structure, by performing the steps of:
receiving a first data stream comprising a plurality of events;
determining a component of the graph data structure corresponding to an event from the plurality of events;
transforming the component of the graph data structure into a key-value record;
publishing the key-value record into a second data stream for storage into a key-value data store; and
storing the key-value record from the second data stream into the key-value data store.

13. The one or more non-transitory computer readable media of claim 12, wherein the steps further comprise:
receiving a request to traverse the graph data structure based upon a query via an application programming interface (API);
performing a breadth-first search traversal of the graph data structure based upon the query; and
returning one or more results based upon the query via the API.

14. The one or more non-transitory computer readable media of claim 12, wherein the key-value data store comprises a plurality of namespaces, wherein each namespace of the plurality of namespaces corresponds to at least one of a node type or an edge type of the key-value data store.

15. The one or more non-transitory computer readable media of claim 14, wherein the steps further comprise:
receiving a request to traverse the graph data structure based upon a query via an application programming interface (API);
performing a breadth-first search traversal of the graph data structure based upon the query based on a set of parallelized queries across the plurality of namespaces; and
returning one or more results based upon the query via the API.

16. The one or more non-transitory computer readable media of claim 12, wherein the component of the graph data structure comprises a component type, the component type specifying a node type or an edge type.

17. The one or more non-transitory computer readable media of claim 12, wherein the steps further comprise collapsing duplicate events from the plurality of events into the key-value record.

18. The one or more non-transitory computer readable media of claim 12 transforming the component of the graph data structure into the key-value record comprises:
generating an identifier for the component of the graph data structure;
storing the identifier for the component as a key for the key-value record; and
storing one or more component properties as a value of the key-value record.

19. The one or more non-transitory computer readable media of claim 18, wherein the component comprises an edge in the graph data structure, and the one or more component properties comprise one or more identifiers specifying one or more nodes to which the edge is linked.

20. A computer system, comprising:
one or more memories that include instructions; and
one or more processors that are coupled to the one or more memories and,
when executing the instructions, are configured to store data in a graph data structure, by performing the operations of:
receiving a first data stream comprising a plurality of events;
determining a component of the graph data structure corresponding to an event from the plurality of events;
transforming the component of the graph data structure into a key-value record;
publishing the key-value record into a second data stream for storage into a key-value data store; and
storing the key-value record from the second data stream into the key-value data store.
